(19) United States
(12) Patent Application Publication
(10) Pub. No.: US 2026/0251881 A1
(43) Pub. Date: Aug. 27, 2026

(54) CAMERA MODULE

(71) Applicant: SAMSUNG ELECTRO-MECHANICS CO., LTD., Suwon-si (KR)

(72) Inventors: Young An CHOI, Suwon-si (KR); Hyuk Joo KIM, Suwon-si (KR)

(73) Assignee: SAMSUNG ELECTRO-MECHANICS CO., LTD., Suwon-si (KR)

(21) Appl. No.: 19/418,168

(22) Filed: Dec. 12, 2025

(30) Foreign Application Priority Data
Feb. 26, 2025 (KR) 10-2025-0025376

(51) Int. Cl. G02B 7/02; G03B 11/04; G03B 30/00

(52) U.S. Cl. CPC G02B 7/028; G03B 11/043; G03B 30/00

(57) ABSTRACT

A camera module includes a lens barrel having a first space extending from an end surface of the lens barrel, and a second space different from the first space, wherein the first space is configured to accommodate a lens having an optical axis; and a cover member coupled to the lens barrel and configured to prevent separation of the lens accommodated in the lens barrel. The second space has a thermal conductivity different from thermal conductivities of the lens and the lens barrel.

### CROSS-REFERENCE TO RELATED APPLICATIONS

This application claims the benefit under 35 USC 119(a) of Korean Patent Application No. 10-2025-0025376 filed on Feb. 26, 2025, in the Korean Intellectual Property Office, the entire disclosure of which is incorporated herein by reference for all purposes.

### BACKGROUND

### 1. Field

The present disclosure relates to a camera module configured to minimize degradation in optical performance caused by high temperature.

### 2. Description of the Background

A camera module may include one or more lenses. In general, a lens of the camera module may be formed of glass. A small camera module may be mounted in portable electronic devices or in vehicle bumpers. A reduction in size and weight of a camera module may be desired, which may necessitate forming the lens from a plastic material. However, the lens formed of a plastic material is likely to undergo deformation or performance degradation due to high temperatures. For example, when the lens is made of a plastic material, it may expand under high-temperature conditions, causing a shift in its alignment within the lens barrel and thereby reducing the optical performance of the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel having a first space extending from an end surface of the lens barrel, and a second space different from the first space, wherein the first space is configured to accommodate a lens having an optical axis; and a cover member coupled to the lens barrel and configured to prevent separation of the lens accommodated in the lens barrel. The second space has a thermal conductivity different from thermal conductivities of the lens and the lens barrel.

The second space may extend in an optical axis direction.

A depth of the second space in an optical axis direction may be equal to or greater than a thickness of a rib of the lens in the optical axis direction.

An outer circumferential surface of the lens barrel and an inside surface of the cover member may each have a screw portion. The second space may be disposed between the lens and the screw portion of the lens barrel.

A width of the second space may decrease from one end toward another end.

The lens barrel may have a coefficient of thermal expansion lower than a coefficient of thermal expansion of the lens.

The cover member may have a coefficient of thermal expansion lower than a coefficient of thermal expansion of the lens barrel.

In another general aspect, a camera module includes a lens barrel having a first space extending from an end surface of the lens barrel, and a second space different from the first space, wherein the first surface is configured to accommodate a lens; a cover member configured to fix and prevent separation of the lens; a first extension portion extending from one end of the lens barrel; and a second extension portion extending from the one end of the lens barrel and spaced apart from the first extension portion with the second space interposed therebetween.

The first extension portion may be longer than the second extension portion.

The first extension portion may have a screw portion screwable to the cover member.

A width of the second space may decrease from one end toward another end.

The lens may include a plurality of lenses, and the first extension portion may be configured to contact a foremost lens of the plurality of lenses.

The cover member may be coupled to the first extension portion to press an edge of the foremost lens.

The lens may include a plurality of lenses, and the second extension portion may be in contact with at least one of the plurality of lenses.

A length of the second extension portion may be greater than a thickness of a rib of a lens in contact with the second extension portion.

The second extension portion may be more flexible and deformable than the first extension portion.

Other features and aspects will be apparent from the following detailed description, the drawings, and the claims.

### BRIEF DESCRIPTION OF DRAWINGS

FIG. 1 is a configuration diagram of a camera module according to an example embodiment of the present disclosure.

FIGS. 2 and 3 are enlarged views of portion “A” illustrated in FIG. 1.

FIGS. 4 and 5 are enlarged views of portion “A” according to a modification of the camera module illustrated in FIG. 1.

FIG. 6 is a configuration diagram of a camera module according to another example embodiment of the present disclosure.

FIGS. 7 and 8 are enlarged views of portion “A” illustrated in FIG. 6.

FIGS. 9 and 10 are enlarged views of portion “A” according to a modification of the camera module illustrated in FIG. 6.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

A camera module according to an example embodiment of the present disclosure may include a lens barrel and a cover member. The lens barrel may accommodate a lens. For example, the lens barrel may accommodate two or more lenses sequentially disposed along an optical axis. However, the number of lenses accommodated in the lens barrel is not limited to two. The cover member may prevent the separation of the lens. For example, the cover member may be in contact with a portion of the lens accommodated in the lens barrel or may press a portion of the lens, thereby preventing the lens from being separated from the lens barrel. In the camera module, according to an example embodiment, the lens barrel may include a specific component. For example, the lens barrel may include a second space having thermal conductivity different from that of the lens accommodated in the lens barrel and that of the lens barrel. As a specific example, the second space may have thermal conductivity lower than that of the lens and that of the lens barrel. The second space formed as described above may block or reduce the transfer of external heat from the lens barrel to the lens. In addition, the second space may serve to absorb stress caused by the expansion deformation of the lens.

A camera module according to another example embodiment of the present disclosure may include a lens barrel and a cover member. The lens barrel may accommodate a lens. For example, the lens barrel may accommodate two or more lenses sequentially disposed along an optical axis. However, the number of lenses accommodated in the lens barrel is not limited to two. The cover member may prevent the separation of the lens. For example, the cover member may be in contact with a portion of the lens accommodated in the lens barrel or may press a portion of the lens, thereby preventing the lens from being separated from the lens barrel. In a camera module according to another example embodiment, the lens barrel may include a specific component. For example, a first extension portion and a second extension portion, extending in one direction, may be formed at one end of the lens barrel. The first extension portion and the second extension portion may be formed to be spaced apart from each other by a predetermined distance. In addition, a second space having a predetermined size may be formed between the first extension portion and the second extension portion. The second space formed as described above may block or reduce the transfer of external heat from the lens barrel to the lens. In addition, the second space may serve to absorb stress caused by the expansion deformation of the lens.

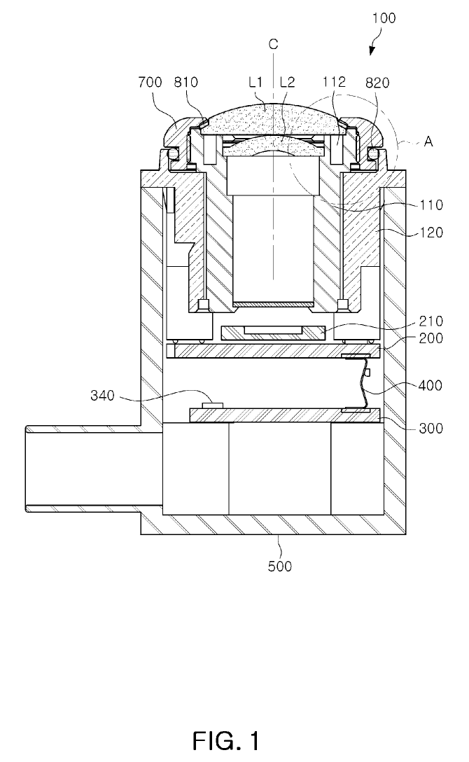

Hereinafter, an example embodiment of the present disclosure will be described in detail with reference to the accompanying drawings. First, a camera module according to an example embodiment will be described with reference to FIGS. 1 to 5.

A camera module 100 according to the present example embodiment may include a lens barrel 110, a barrel holder 120, a first substrate 200, a second substrate 300, and a terminal connection member 400, as illustrated in FIG. 1. However, components of the camera module 100 are not limited to the above-described members. For example, the camera module 100 may further include a housing 500, a cover member 700, and airtight members 810 and 820.

The lens barrel 110 has a first space extending from an end surface of the lens barrel that may accommodate one or more lenses L1 and L2 therein. For example, the lens barrel 110 may accommodate first and second lenses L1 and L2 sequentially disposed from an object side along an optical axis. However, the number of lenses accommodated in the lens barrel 110 is not limited to two. For example, the lens barrel 110 may accommodate two or more lenses. The lens barrel 110 may have a coefficient of thermal expansion different from that of the lenses L1 and L2 accommodated therein. As an example, the lens barrel 110 may have a coefficient of thermal expansion lower than that of the first lens L1 or the second lens L2. As another example, the lens barrel 110 may have a coefficient of thermal expansion lower than that of the lenses L1 and L2 accommodated therein.

At least one of the lenses L1 and L2 accommodated in the lens barrel 110 may have a different coefficient of thermal expansion. For example, a foremost first lens L1 may have a coefficient of thermal expansion different from that of the other lenses L2. As another example, the first lens L1 may be formed of a glass material having a low coefficient of thermal expansion, and at least one of the other lenses L2 may be formed of a plastic material having a high coefficient of thermal expansion.

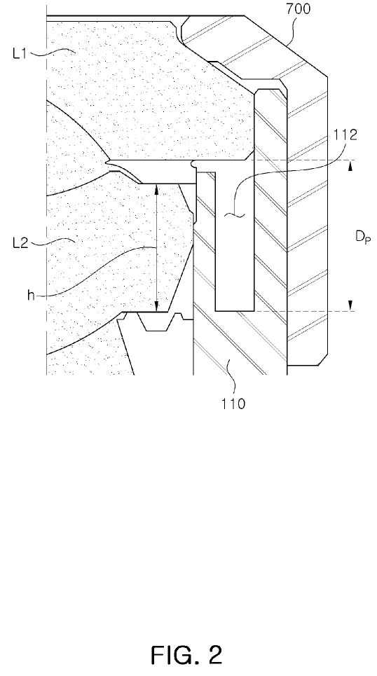

In the lens barrel 110, a specific space other than the space for accommodating the lenses L1 and L2 may be further formed. For example, the second space 112 may be formed at one end of the lens barrel 110, as illustrated in FIG. 1. The second space 112 may be formed to have a predetermined depth (Dp) (see FIG. 2) along an optical axis C from one end of the lens barrel 110. The second space 112 may be formed in a specific position. For example, the second space 112 may be formed to be adjacent to the second lens L2 having a high thermal expansion rate. However, a formation position of the second space 112 is not limited to an adjacent portion of the second lens L2. The second space 112 may be formed to have a predetermined size. For example, the depth (Dp) of the second space 112 may be equal to or greater than a thickness (h) of a rib of an adjacent second lens L2.

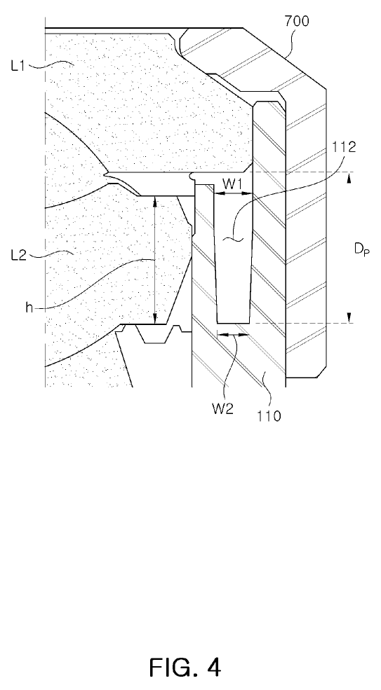

The second space 112 may have a specific shape. For example, as illustrated in FIG. 4, the second space 112 may have a width decreasing from one side toward the other side. In addition, a width (W1) of a portion of the second space 112, most adjacent to the first lens L1, may be greater than a width (W2) of a portion of the second space 112, most distant from the first lens L1.

The barrel holder 120 may be coupled to the lens barrel 110. For example, an accommodation space 122 for accommodating the lens barrel 110 may be formed in the barrel holder 120. The barrel holder 120 may fix the lens barrel 110 to the housing 500. For example, the barrel holder 120 may be coupled to the housing 500 via a flange portion 124 to fix a position of the lens barrel 110 with respect to the housing 500. The barrel holder 120 may include a component for coupling or contacting the first substrate 200.

The first substrate 200 may be coupled to the barrel holder 120. For example, the first substrate 200 may be coupled to the barrel holder 120 via a fastening means. As a specific example, the first substrate 200 may be fixed to the barrel holder 120 via a bolt or an adhesive. However, a coupling means between the first substrate 200 and the barrel holder 120 is not limited to the bolt and the adhesive.

An electronic component desired for the operation of the camera module 100 may be mounted on the first substrate 200. For example, an image sensor 210 for converting an optical signal incident through the lens L1 of the lens barrel 110 into an electrical signal may be mounted on the first substrate 200. However, a component of an electronic component mounted or installed on the first substrate 200 is not limited to the image sensor 210. For example, a passive device or a driving device for assisting in driving the image sensor 210 may be further mounted on the first substrate 200.

The first substrate 200 may include a component for being electrically connected to another component (for example, the second substrate 300). For example, one or more first connection terminals may be formed on one surface of the first substrate 200. The first connection terminal may be electrically connected to the image sensor 210. For example, the first connection terminal may be electrically connected to the image sensor 210 through a printed circuit formed on the inside or surface of the first substrate 200. Accordingly, an electrical signal of the image sensor 210 may be transmitted to the second substrate 300 through the first connection terminal.

The second substrate 300 may be disposed to be spaced apart from the first substrate 200 by a predetermined distance. For example, the second substrate 300 may be disposed to be spaced apart from one surface (that is, a lower surface) of the first substrate 200 by a predetermined distance so as not to interfere with an electronic component mounted on an upper portion of the second substrate 300 or a lower surface of the first substrate 200.

An electronic component for driving the camera module 100 may be mounted on the second substrate 300. For example, a power supply unit 340 for supplying current for driving the image sensor 210 may be mounted on one surface or the other surface of the second substrate 300. However, the electronic component mounted on the second substrate 300 is not limited to the power supply unit 340. For example, a passive device or the like for driving the image sensor 210 may be further mounted on the second substrate 300.

The second substrate 300 may include a component for being electrically connected to the first substrate 200. For example, one or more second connection terminals may be formed on one surface (an upper surface based on FIG. 1) of the second substrate 300. The second connection terminal may be electrically connected to the power supply unit 340 described above. For example, the second connection terminal may be electrically connected to the power supply unit 340 through a printed circuit formed on the inside or surface of the second substrate 300. Accordingly, a current of the power supply unit 340 may be supplied externally through the second connection terminal.

The terminal connection member 400 may electrically connect the first substrate 200 and the second substrate 300 to each other. In addition, the terminal connection member 400 may be in contact with each of the first connection terminal 220 of the first substrate 200 and the second connection terminal of the second substrate 300 to electrically connect the first substrate 200 and the second substrate 300 to each other. The terminal connection member 400 may be fixed to the first substrate 200 or the second substrate 300. For example, one end of the terminal connection member 400 may be fixed to the first connection terminal of the first substrate 200 or the second connection terminal of the second substrate 300.

The housing 500 may accommodate key components of the camera module 100. For example, a lens module 100, the first substrate 200, the terminal connection member 400, and the second substrate 300 may be disposed in an accommodation space 510 of the housing 500. The lens module 100, the first substrate 200, the terminal connection member 400, and the second substrate 300 may be sequentially disposed in the accommodation space 510 of the housing 500. In addition, the second substrate 300 may be disposed in a lowermost portion of the accommodation space 510, and the terminal connection member 400, the first substrate 200, and the lens module 100 may be sequentially disposed above the second substrate 300. The lens module 100, the first substrate 200, the terminal connection member 400, and the second substrate 300 may be sequentially stacked in the accommodation space 510 of the housing 500, and may be coupled or electrically connected to each other. For example, the first substrate 200, the terminal connection member 400, and the second substrate 300 may be stacked in the accommodation space 510 of the housing 500, and at the same time may be electrically connected to each other.

The cover member 700 may fix the lens barrel 110 to the barrel holder 120. For example, the cover member 700 may be coupled to the barrel holder 120 using a method such as screw fastening or adhesive to firmly fix the lens barrel 110 to the barrel holder 120. The cover member 700 may have a coefficient of thermal expansion different from that of the lens barrel 110 or the lenses L1 and L2. As an example, the cover member 700 may have a coefficient of thermal expansion lower than that of the lens barrel 110. As another example, the cover member 700 may have a coefficient of thermal expansion lower than that of the lenses L1 and L2 accommodated in the lens barrel 110.

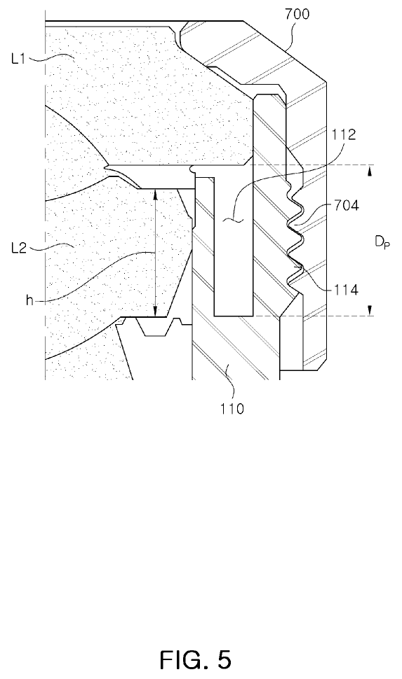

The cover member 700 may be firmly coupled to the lens barrel 110. For example, an outer circumferential surface of the lens barrel 110 and an inner circumferential surface of the cover member 700 may have screw portions 114 and 704, respectively, as illustrated in FIG. 5. The screw portion 114 of the lens barrel 110 and the screw portion 704 of the cover member 700 may be formed at specific points. As an example, the screw portion 114 of the lens barrel 110 and the screw portion 704 of the cover member 700 may be formed on portions adjacent to the second space 112. As another example, the screw portions 114 and 704, the second space 112, and the second lens L2 may be positioned in parallel with each other in a direction intersecting the optical axis C.

The airtight members 810 and 820 may shield a gap between members of the camera module 100. For example, a first airtight member 810 may shield a gap between the lens barrel 110 and the cover member 700, and a second airtight member 820 may shield a gap between the lens barrel 110 and the barrel holder 120. For reference, although not illustrated in FIG. 1, an airtight member may be further disposed between the barrel holder 120 and the housing 500.

The camera module 100 configured as described above may reduce degradation or a decrease in resolution of the camera module 100 that may occur in a high-temperature environment. For example, the camera module 100, according to the present example embodiment, may reduce degradation or a decrease in resolution of the camera module 100 by internally absorbing expansion deformation and thermal stress of the lens L2 that may occur in a high-temperature environment.

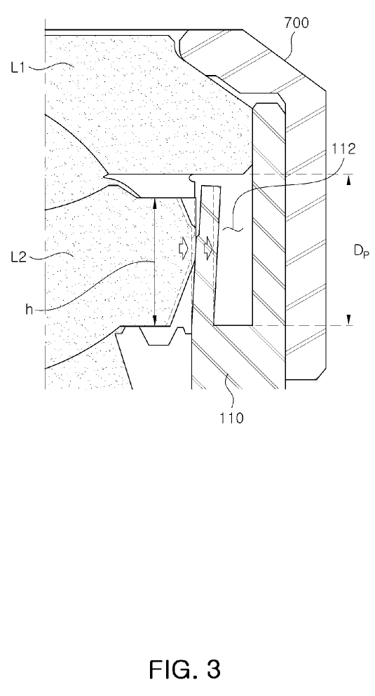

In addition, the lens L2, having a high thermal expansion rate in the high-temperature environment, may easily expand in a direction intersecting the optical axis, as illustrated in FIG. 3. However, a camera module according to the related art may not include any component capable of absorbing or reducing expansion deformation of a lens. For this reason, in the camera module according to the related art, the lens may be distorted or deformed in an optical axis direction or an arbitrary direction in a high-temperature environment, and thus may fail to exhibit the original optical performance thereof.

However, in the camera module 100 according to the present example embodiment, expansion deformation stress of the lens L2 may be absorbed or reduced through the second space 112, as illustrated in FIG. 3, thereby enabling reliable optical performance even in a high-temperature environment.

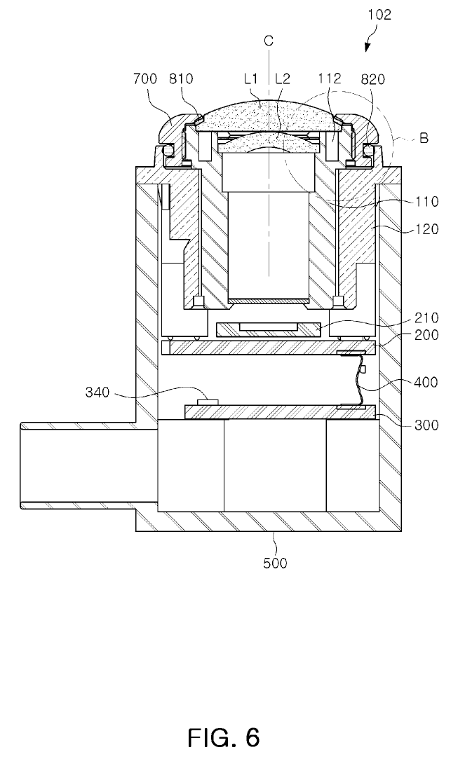

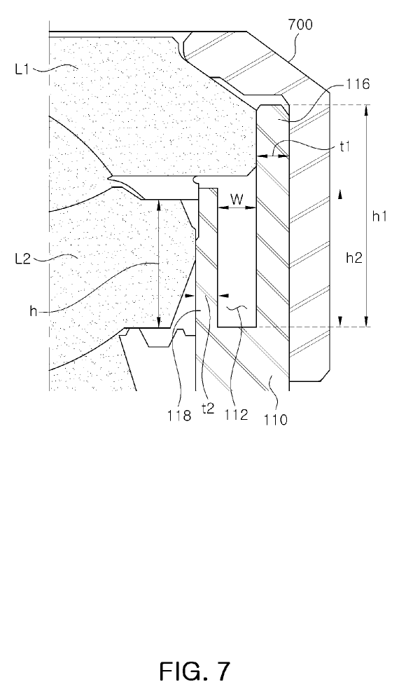

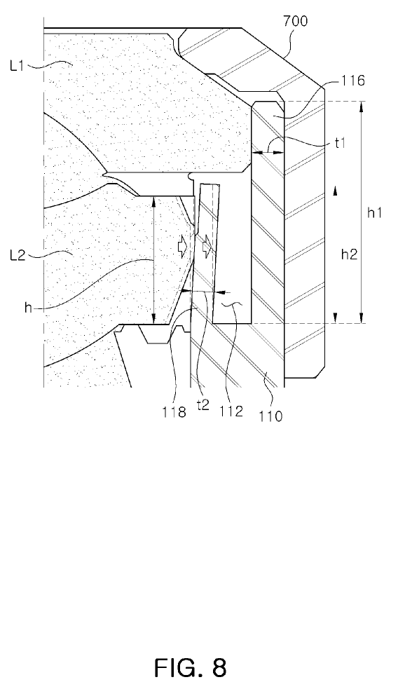

Hereinafter, a camera module according to another example embodiment will be described with reference to FIGS. 6 to 10.

A camera module 102 according to the present example embodiment may include a lens barrel 110, a barrel holder 120, a first substrate 200, a second substrate 300, and a terminal connection member 400, as illustrated in FIG. 6. However, components of the camera module 102 are not limited to the above-described members. For example, the camera module 102 may further include a housing 500, a cover member 700, and airtight members 810 and 820.

The lens barrel 110 may accommodate one or more lenses L1 and L2 therein. For example, the lens barrel 110 may accommodate first and second lenses L1 and L2 sequentially disposed from an object side along an optical axis. However, the number of lenses accommodated in the lens barrel 110 is not limited to two. For example, the lens barrel 110 may accommodate two or more lenses. The lens barrel 110 may have a coefficient of thermal expansion different from that of the lenses L1 and L2 accommodated therein. As an example, the lens barrel 110 may have a coefficient of thermal expansion lower than that of the first lens L1 or the second lens L2. As another example, the lens barrel 110 may have a coefficient of thermal expansion lower than that of the lenses L1 and L2 accommodated therein.

At least one of the lenses L1 and L2 accommodated in the lens barrel 110 may have a different coefficient of thermal expansion. For example, a foremost first lens L1 may have a coefficient of thermal expansion different from that of the other lenses L2. As another example, the first lens L1 may be formed of a glass material having a low coefficient of thermal expansion, and at least one of the other lenses L2 may be formed of a plastic material having a high coefficient of thermal expansion.

The lens barrel 110, according to the present example embodiment, may have a specific component. For example, a first extension portion 116 and a second extension portion 118 may be formed at one end of the lens barrel 110. The first extension portion 116 and the second extension portion 118 may extend in one direction of the lens barrel 110. As a specific example, the first extension portion 116 and the second extension portion 118 may extend in a direction of an optical axis C. The first extension portion 116 and the second extension portion 118 may be formed to be spaced apart from each other by a predetermined distance. For example, the first extension portion 116 and the second extension portion 118 may be formed to be spaced apart from each other by a first distance (w). A space having a predetermined size may be formed between the first extension portion 116 and the second extension portion 118. For example, a second space 112 may be formed between the first extension portion 116 and the second extension portion 118.

The first extension portion 116 and the second extension portion 118 may have different lengths. For example, a length (h1) of the first extension portion 116 may be greater than a length (h2) of the second extension portion 118. The first extension portion 116 and the second extension portion 118 may be in contact with different lenses. For example, the first extension portion 116 may be in contact with a foremost lens (the first lens L1), among lenses accommodated in the lens barrel 110, and the second extension portion 118 may be in contact with a second lens L2 disposed on an upper side of the first lens L1. The second extension portion 118 may be more easily bent and deformed than the second extension portion 116. For example, a thickness (t2) of the second extension portion 118 may be less than a thickness (t1) of the first extension portion 116. However, a length relationship and a thickness relationship between the first extension 116 and the second extension 118 are not limited to the above-described forms.

The first extension portion 116 and the second extension portion 118 may be formed in specific positions. As an example, the first extension portion 116 and the second extension portion 118 may be formed to be adjacent to the second lens L2 having a high coefficient of thermal expansion. As another example, the second extension portion 118 may be in contact with one or more of the lenses accommodated in the lens barrel 110. As a specific example, the second extension portion 118 may be in contact with the second lens L2 having a high coefficient of thermal expansion. The second extension portion 118 may have a predetermined size. For example, the length (h2) of the second extension portion 118 may be equal to or greater than a thickness (h) of a rib of an adjacent second lens L2.

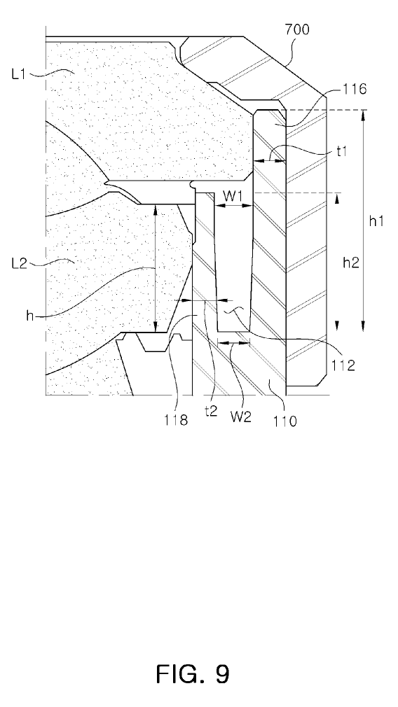

The second space 112, formed between the first extension portion 116 and the second extension portion 118, may have a specific shape. For example, as illustrated in FIG. 9, the second space 112 may have a width decreasing from one side toward the other side. In addition, a width (W1) of a portion of the second space 112, most adjacent to the first lens L1, may be greater than a width (W2) of a portion of the second space 112, most distant from the first lens L1.

The barrel holder 120 may be coupled to the lens barrel 110. For example, an accommodation space 122 for accommodating the lens barrel 110 may be formed in the barrel holder 120. The barrel holder 120 may fix the lens barrel 110 to the housing 500. For example, the barrel holder 120 may be coupled to the housing 500 via a flange portion 124 to fix a position of the lens barrel 110 with respect to the housing 500. The barrel holder 120 may include a component for coupling or contacting the first substrate 200.

The first substrate 200 may be coupled to the barrel holder 120. For example, the first substrate 200 may be coupled to the barrel holder 120 via a fastening means. As a specific example, the first substrate 200 may be fixed to the barrel holder 120 via a bolt or an adhesive. However, a coupling means between the first substrate 200 and the barrel holder 120 is not limited to the bolt and the adhesive.

An electronic component used for the operation of the camera module 102 may be mounted on the first substrate 200. For example, an image sensor 210 for converting an optical signal incident through the lens L1 of the lens barrel 110 into an electrical signal may be mounted on the first substrate 200. However, a component of an electronic component mounted or installed on the first substrate 200 is not limited to the image sensor 210. For example, a passive device or a driving device for assisting in driving the image sensor 210 may be further mounted on the first substrate 200.

The first substrate 200 may include a component for being electrically connected to another component (for example, the second substrate 300). For example, one or more first connection terminals may be formed on one surface of the first substrate 200. The first connection terminal may be electrically connected to the image sensor 210. For example, the first connection terminal may be electrically connected to the image sensor 210 through a printed circuit formed on the inside or surface of the first substrate 200. Accordingly, an electrical signal of the image sensor 210 may be transmitted to the second substrate 300 through the first connection terminal.

The second substrate 300 may be disposed to be spaced apart from the first substrate 200 by a predetermined distance. For example, the second substrate 300 may be disposed to be spaced apart from one surface (that is, a lower surface) of the first substrate 200 by a predetermined distance so as not to interfere with an electronic component mounted on an upper portion of the second substrate 300 or a lower surface of the first substrate 200.

An electronic component used for driving the camera module 102 may be mounted on the second substrate 300. For example, a power supply unit 340 supplying current for driving the image sensor 210 may be mounted on one surface or the other surface of the second substrate 300. However, the electronic component mounted on the second substrate 300 is not limited to the power supply unit 340. For example, a passive device or the like for driving the image sensor 210 may be further mounted on the second substrate 300.

The second substrate 300 may include a component for being electrically connected to the first substrate 200. For example, one or more second connection terminals may be formed on one surface (an upper surface based on FIG. 6) of the second substrate 300. The second connection terminal may be electrically connected to the power supply unit 340 described above. For example, the second connection terminal may be electrically connected to the power supply unit 340 through a printed circuit formed on the inside or surface of the second substrate 300. Accordingly, a current of the power supply unit 340 may be supplied externally through the second connection terminal.

The terminal connection member 400 may electrically connect the first substrate 200 and the second substrate 300 to each other. In addition, the terminal connection member 400 may be in contact with each of the first connection terminal 220 of the first substrate 200 and the second connection terminal of the second substrate 300 to electrically connect the first substrate 200 and the second substrate 300 to each other. The terminal connection member 400 may be fixed to the first substrate 200 or the second substrate 300. For example, one end of the terminal connection member 400 may be fixed to the first connection terminal of the first substrate 200 or the second connection terminal of the second substrate 300.

The housing 500 may accommodate key components of the camera module 102. For example, a lens module 102, the first substrate 200, the terminal connection member 400, and the second substrate 300 may be disposed in an accommodation space 510 of the housing 500. The lens module 102, the first substrate 200, the terminal connection member 400, and the second substrate 300 may be sequentially disposed in the accommodation space 510 of the housing 500. In addition, the second substrate 300 may be disposed in a lowermost portion of the accommodation space 510, and the terminal connection member 400, the first substrate 200, and the lens module 102 may be sequentially disposed above the second substrate 300. The lens module 102, the first substrate 200, the terminal connection member 400, and the second substrate 300 may be sequentially stacked in the accommodation space 510 of the housing 500, and may be coupled or electrically connected to each other. For example, the first substrate 200, the terminal connection member 400, and the second substrate 300 may be stacked in the accommodation space 510 of the housing 500, and at the same time may be electrically connected to each other.

The cover member 700 may fix the lens barrel 110 to the barrel holder 120. For example, the cover member 700 may be coupled to the barrel holder 120 using a method such as screw fastening or adhesive to firmly fix the lens barrel 110 to the barrel holder 120. The cover member 700 may have a coefficient of thermal expansion different from that of the lens barrel 110 or that of the lenses L1 and L2. As an example, the cover member 700 may have a coefficient of thermal expansion lower than that of the lens barrel 110. As another example, the cover member 700 may have a coefficient of thermal expansion lower than that of the lenses L1 and L2 accommodated in the lens barrel 110. The cover member 700 may press a foremost lens (that is, the first lens L1). For example, the cover member 700 may be coupled to the first extension portion 116 to press an edge of the first lens L1.

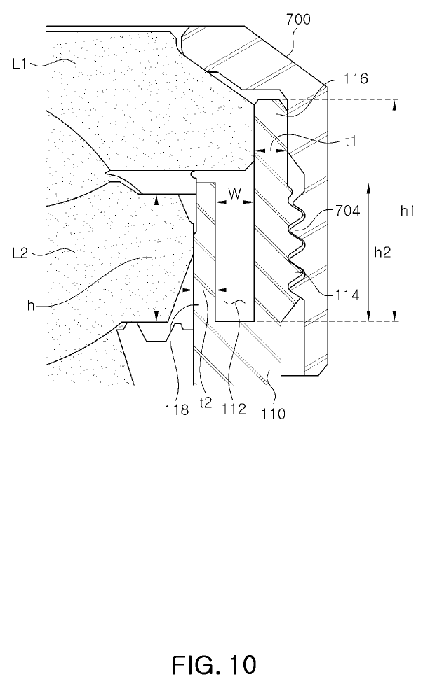

The cover member 700 may be firmly coupled to the lens barrel 110. For example, an outer circumferential surface of the first extension portion 118 and an inner circumferential surface of the cover member 700 may have screw portions 114 and 704, respectively, as illustrated in FIG. 10. The screw portion 114 of the lens barrel 110 and the screw portion 704 of the cover member 700 may be formed at specific points. As an example, the screw portion 114 of the lens barrel 110 and the screw portion 704 of the cover member 700 may be formed on portions adjacent to the second space 112. As another example, the screw portions 114 and 704, the second space 112, and the second lens L2 may be positioned in parallel with each other in a direction intersecting the optical axis C.

The airtight members 810 and 820 may shield a gap between members of the camera module 102. For example, a first airtight member 810 may shield a gap between the lens barrel 110 and the cover member 700, and a second airtight member 820 may shield a gap between the lens barrel 110 and the barrel holder 120. For reference, although not illustrated in FIG. 6, an airtight member may be further disposed between the barrel holder 120 and the housing 500, as desired.

The camera module 102 configured as described above may reduce degradation or a decrease in resolution of the camera module 102 that may occur in a high-temperature environment. For example, the camera module 102, according to the present example embodiment, may reduce degradation or a decrease in resolution of the camera module 102 by internally absorbing expansion deformation and thermal stress of the lens L2 that may occur in the high-temperature environment.

In addition, the lens L2, having a high thermal expansion rate in the high-temperature environment, may easily expand in a direction intersecting the optical axis, as illustrated in FIG. 3. However, a camera module according to the related art may not include any component capable of absorbing or reducing expansion deformation of a lens. For this reason, in the camera module according to the related art, the lens may be distorted or deformed in an optical axis direction or an arbitrary direction in the high-temperature environment, and thus may fail to exhibit the original optical performance thereof.

However, in the camera module 102, according to the present example embodiment, expansion deformation stress of the lens L2 may be absorbed or reduced through the second space 112, as illustrated in FIG. 3, thereby enabling reliable optical performance even in the high-temperature environment.

An aspect of the present disclosure is to provide a camera module configured to reduce degradation in optical performance caused by high temperature.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel having a first space extending from an end surface of the lens barrel, and a second space different from the first space, wherein the first space is configured to accommodate a lens having an optical axis; and
a cover member coupled to the lens barrel and configured to prevent separation of the lens accommodated in the lens barrel,
wherein the second space has a thermal conductivity different from thermal conductivities of the lens and the lens barrel.

2. The camera module of claim 1, wherein the second space extends in an optical axis direction.

3. The camera module of claim 1, wherein a depth of the second space in an optical axis direction is equal to or greater than a thickness of a rib of the lens in the optical axis direction.

4. The camera module of claim 1, wherein
an outer circumferential surface of the lens barrel and an inside surface of the cover member each has a screw portion, and
the second space is disposed between the lens and the screw portion of the lens barrel.

5. The camera module of claim 1, wherein a width of the second space decreases from one end toward another end.

6. The camera module of claim 1, wherein the lens barrel has a coefficient of thermal expansion lower than a coefficient of thermal expansion of the lens.

7. The camera module of claim 1, wherein the cover member has a coefficient of thermal expansion lower than a coefficient of thermal expansion of the lens barrel.

8. A camera module comprising:
a lens barrel having a first space extending from an end surface of the lens barrel, and a second space different from the first space, wherein the first surface is configured to accommodate a lens;
a cover member configured to fix and prevent separation of the lens;
a first extension portion extending from one end of the lens barrel; and
a second extension portion extending from the one end of the lens barrel and spaced apart from the first extension portion with the second space interposed therebetween.

9. The camera module of claim 8, wherein the first extension portion is longer than the second extension portion.

10. The camera module of claim 8, wherein the first extension portion has a screw portion screwable to the cover member.

11. The camera module of claim 8, wherein a width of the second space decreases from one end toward another end.

12. The camera module of claim 8, wherein the lens comprises a plurality of lenses, and the first extension portion is configured to contact a foremost lens of the plurality of lenses.

13. The camera module of claim 12, wherein the cover member is coupled to the first extension portion to press an edge of the foremost lens.

14. The camera module of claim 8, wherein the lens comprises a plurality of lenses, and the second extension portion is in contact with at least one of the plurality of lenses.

15. The camera module of claim 8, wherein a length of the second extension portion is greater than a thickness of a rib of a lens in contact with the second extension portion.

16. The camera module of claim 8, wherein the second extension portion is more flexible and deformable than the first extension portion.
